(19) United States
(12) Patent Application Publication
(10) Pub. No.: US 2014/0218179 A1
(43) Pub. Date: Aug. 7, 2014

(54) WIRELESS REMOTE-CONTROL SYSTEM

(71) Applicant: Beijing Sigmachip Co., Ltd., Beijing (CN)

(72) Inventor: Lei JIN, Beijing (CN)

(73) Assignee: BEIJING SIGMACHIP CO., LTD., Beijing (CN)

(21) Appl. No.: 13/845,065

(22) Filed: Mar. 17, 2013

(30) Foreign Application Priority Data
Feb. 7, 2013 (CN) 201310049729.3

(51) Int. Cl. G08C 17/02

(52) U.S. Cl. CPC G08C 17/02
USPC 340/12.5

(57) ABSTRACT

A wireless remote-control system includes a Logical Link Control and an Adaptation Protocol (L2CAP) interface, a master control device and at least one device to be controlled. A first processing unit of the master control device receives a remote-control instruction for controlling a target device to transmit the same through the L2CAP interface. The remote-control instruction includes identification information of the target device. The device to be controlled is assigned with identification information of the device to be controlled. A second processing unit of the device to be controlled receives the remote-control instruction through the L2CAP interface and determines if its identification information matches the identification information of the target device. When they match, the device to be controlled executes the remote-control instruction.

### RELATED APPLICATION

This application claims priority to Chinese Application Serial Number 201310049729.3, filed Feb. 7, 2013, which is herein incorporated by reference.

### BACKGROUND

1. Field of Invention

The invention relates to a remote-control system. More particularly, the invention relates to a wireless remote-control system.

2. Description of Related Art

The bluetooth communication protocol is a wireless communication protocol commonly used in current computers, handheld devices and various mobile devices. Through the bluetooth communication protocol, the information can be shared by transmitting irradiation receiving various data among bluetooth-compatible devices,

However, in order to provide different functions, the bluetooth communication protocol defines many different levels, which is very complex. As such, for a general manufacturer, developing a bluetooth-compatible device needs to cost a large amount of human labor and use a strong hardware component, having a high cost. For a simple remote-control device, such as a remote-control vehicle and a lamp capable of being controlled remotely, it is not economic to use the bluetooth communication protocol as the interface for controlling the remote-control device.

Thus, there is a need to find ways in which to remote-control a simple remote-control device,

### SUMMARY

In view of the above, an aspect of the invention provides a wireless remote-control system. In the wireless remote-control system, a device to be controlled executes the received remote-control instruction only when the received remote-control instruction matches the identification information thereof. The wireless remote-control system includes a Logical Link Control and Logical Link Control and Adaptation Protocol (L2CAP) interface, a master control device and at least one device to be controlled. A master control device includes a user interface and a first processing unit electrically connected to each other. A first processing unit includes a first instruction receiving module and an instruction transmitting module. The first instruction receiving module receives a remote-control instruction for a target device through a user interface. The remote-control instruction includes identification information of the target device of the target device. The instruction transmitting module transmits the remote-control instruction through the L2CAP interface. The device to be controlled has identification information of the device to be controlled. A second processing unit of the device to be controlled includes a second instruction receiving module, an identification information determining module and an instruction execution module. The second instruction receiving module receives the remote-control instruction through the L2CAP interface, The identification information determining module determines whether the identification information of the target device included in the remote-control instruction matches the identification information of the device to be controlled. When the identification information of the target device included in the remote-control instruction matches the identification information of the device to be controlled, the instruction execution module controls the device to be controlled to execute the remote-control instruction.

### BRIEF DESCRIPTION OF THE DRAWINGS

FIG. 1 illustrates a function block diagram of a wireless remote-control system according to an embodiment of the invention.

### DETAILED DESCRIPTION

The spirit of the invention will be described clearly through the drawings and the detailed description as follows. Any of those of ordinary skills in the art can make modifications and variations from the technology taught in the invention after understanding the embodiments of the invention, without departing from the sprite and scope of the invention.

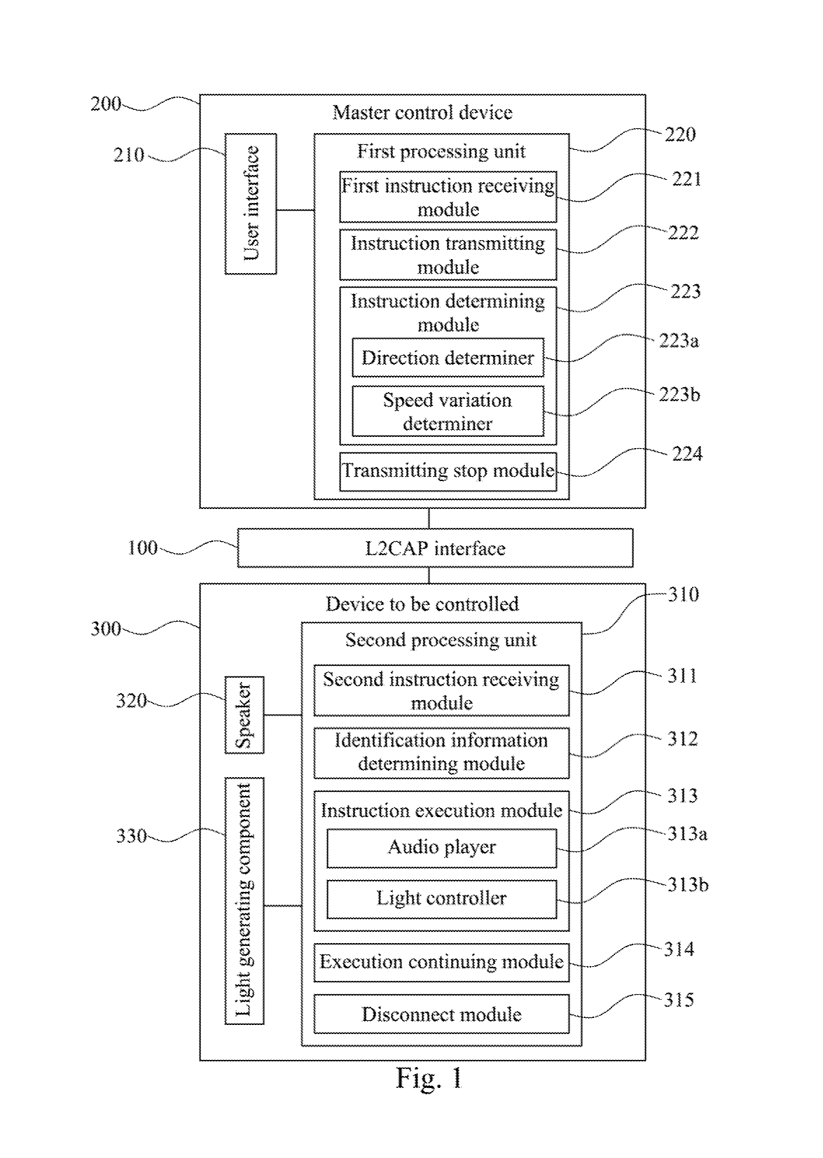

Referring to FIG. 1, it illustrates a function block diagram of a wireless remote-control system according to an embodiment of the invention. In the wireless remote-control system, a device to be controlled executes the received remote-control instruction only when the received remote-control instruction matches the identification information thereof.

The wireless remote-control system includes a Logical Link Control and Logical Link Control and Adaptation Protocol (L2CAP) interface 100, a master control device 200 and at least one device to be controlled 300. In some embodiments of the invention, hardware and a communication protocol corresponding to the L2CAP interface 100 can be respectively arranged on the master control device 200 and the device to be controlled 300, so as to form the L2CAP interface 100. In some other embodiments of the invention, the L2CAP interface 100 may also be provided in other ways, which are not limited to this specification.

The master control device 200 may be a cell phone, a computer or other devices which can transmit data through the L2CAP interface 100. The master control device 200 includes a user interface 210 and a first processing unit 220 electrically connected to each other. The user interface 210 may be a mouse, a keyboard, a graphical user interface (GUI), a touch panel or user interfaces of other types.

The first processing unit 220 includes a first instruction receiving module 221 and an instruction transmitting module 222. In some embodiments of the invention, the first instruction receiving module 221 and the instruction transmitting module 222 can be practiced by computer applications, so the first processing unit 220 can install and perform them. In some other embodiments of the invention, the first instruction receiving module 221 and instruction transmitting module 222 can be pre-stored in a storage component, so as to be accessed and performed by the first processing unit 220.

The first instruction receiving module 221 receives a remote-control instruction for a target device through the user interface 210. The remote-control instruction includes identification information of the target device. In other words, when wanting to perform a remote control, the user of the master control device 200 can operates through the user interface 210 to generate a remote-control instruction for the target device to he controlled remotely, which is received by the first instruction receiving module 221 .The instruction transmitting module 222 transmits the remote-control instruction through the L2CAP interface 100.

The device to be controlled 300 has identification information of the device to be controlled 300. The device to be controlled 300 can be any electronic device which can receive data through the L2CAP interface 100 and can be controlled remotely. A second processing unit 310 of the device to be controlled 300 includes a second instruction receiving module 311, an identification information determining module 312 and an instruction execution module 313. The second instruction receiving module 311 receives the remote-control instruction through the L2CAP interface 100.

The identification information determining module 312 determines whether the identification information of the target device included in the remote-control instruction matches the identification information of the device to be controlled 300.

When the identification information of the target device included in the remote-control instruction matches the identification information of the device to be controlled 300, it means that the device to be controlled 300 is the device which the user of the master control device 200 wants to control remotely. Therefore, when the identification information of the target device included in the remote-control instruction matches the identification information of the device to be controlled 300, the instruction execution module 313 controls the device to be controlled 300 to execute the remote-control instruction. As such, only using the L2CAP, the remote control can be realized, without using the complex bluetooth communication protocol, which reduces the implementation complexity. Furthermore, the expensive cost of the bluetooth-related hardware can be avoided, and the manufacturing cost of the master control device 200 and the device to be controlled 300 is reduced.

In some embodiments of the invention, the second processing unit 310 may further include a disconnect module 314. After the data of the remote-control instruction is received, the disconnect module 314 disconnects the connection to the master control device 200 established through the L2CAP interface 100. As such, the electric power consumption of the device to be controlled 300 can be further reduced.

In some other embodiments of the invention, the first processing unit 220 may further include an instruction determining module 223. When the first instruction receiving module 221 receives a next remote-control instruction for the same target device through the user interface 210, it is determined whether the next remote-control instruction is the same as the previously transmitted remote-control instruction. If the next remote-control instruction is not the same as the previously transmitted remote-control instruction, the instruction transmitting module 222 transmits the next remote-control instruction for the same target device.

Furthermore, if the next remote-control instruction is the same as the previous transmitted remote-control instruction, a transmitting stop module 224 of the first processing unit 220 drives the instruction transmitting module 222 to stop transmitting the next remote-control instruction for the same target device. Corresponding to such a function, a execution continuing module 315 of the second processing unit 310 continuously drives the device to be controlled 300 to execute the same remote-control instruction before the next remote-control instruction matching its identification information is received. As such, if wanting to remotely control the target device to perform the same instruction continuously, the user of the master control device 200 only needs to transmit the remote-control instruction for once, without transmitting the same instruction repeatedly, which can reduce the electric power consumption required for transmitting.

In some application scenario of the invention, the device to be controlled 300 may be a movable device with a moving capability, such as a remote-control vehicle, a remote-control airplane or other types of electronic devices with the moving capability. Therefore, a direction determiner 223a of the instruction determining module 223 can determines whether the remote-controlled moving direction of the next remote-control instruction requested for the same target device is the same as that of the previous transmitted remote-control instruction. When the remote-controlled moving directions are different, the instruction transmitting module 222 transmits the next remote-control instruction with the different moving direction. For example, when the user of the master control device 200 wants to enable the target device (such as the device to be controlled 300) to move forward continuously, the master control device 200 only needs to transmit the remote-control instruction of moving forward for once, and the device to be controlled 300 moves forward continuously after receiving the remote-control instruction of moving forward matching the identification information. Thereafter, the master control device 200 only needs to transmit the next remote-control instruction when the user wants to change the moving direction.

Furthermore, a speed variation determiner 223b of the instruction determining module 223 can determine whether the speed variation request included in the next remote-control instruction is the same as that included in the previous transmitted remote-control instruction (for example, the requirement for two remote-control instructions are both increasing the speed , reducing the speed, stopping the speed variation of other types). When the required speed variations are different, the instruction transmitting module 222 transmits the next remote-control instruction with the different speed variation request. For example, when the user of the master control device 200 wants to enable the target device (such as the device to be controlled 300) to speed up continuously, the master control device 200 only needs to transmit the remote-control instruction of speeding up for once, and the device to be controlled 300 speeds up continuously after receiving the remote-control instruction of speeding up matching the identification information. Thereafter, the master control device 200 only needs to transmit the next remote-control instruction when the user wants to change the speed variation manner.

In some other embodiments of the invention, the device to be controlled 300 may further include a speaker 320 electrically connected to the second processing unit 310. Accordingly, when the identification information of the target device included in the remote-control instruction matches the identification information of the device to be controlled 300, an audio player 313a of the instruction execution module 313 can control the speaker 320 of the device to be controlled 300 to play the audio signal to be played included in the remote-control instruction. As such, the device to be controlled 300 can produce a sound without additionally pre-storing any audio signal in a storage component.

In some other embodiments of the invention, the device to be controlled 300 may further include a light generating component 330 electrically connected to the second processing unit 310. Therefore, a light controller 313b of the instruction execution module 313 can control switching of the light generating component 330 or the color of the generated light according to the remote-control instruction matching the identification information. As such, the light can be controlled without using any complex bluetooth communication protocol.

Although the invention has been disclosed with reference to the above embodiments, these embodiments are not intended to limit the invention. It will be apparent to those of skills in the art that various modifications and variations can be made without departing from the spirit and scope of the invention. For example the system can be used for remotely controlling other different devices. Therefore, the scope of the invention shall be defined by the appended claims.

What is claimed is:

1. A wireless remote-control system, comprising:
a Logical Link Control and Logical Link Control and Adaptation Protocol (L2CAP) interface;
a master control device, comprising:
a user interface; and
a first processing unit, electrically connected to the user interface, wherein the first processing unit comprises:
a first instruction receiving module, which receives a remote-control instruction for a target device through the user interface, wherein the remote-control instruction comprises identification information of the target device; and
an instruction transmitting module which transmits the remote-control instruction through the L2CAP interface; and
at least one device to he controlled, wherein the device to be controlled has identification information of the device to be controlled, and the device to be controlled comprises:
a second processing unit, comprising:
a second instruction receiving module which receives the remote-control instruction through the L2CAP interface;
an identification information determining module, which determines whether the identification information of the target device comprised in the remote-control instruction matches the identification information of the device to be controlled; and
an instruction execution module, wherein when the identification information of the target device comprised in the remote-control instruction matches the identification information of the device to be controlled, the instruction execution module controls the device to be controlled to execute the remote-control instruction,

2. The wireless remote-control system of claim 1, wherein the second processing unit further comprises:
a disconnect module, wherein when data of the remote-control instruction is received, the disconnect module disconnects the connection to the master control device through the L2CAP interface,

3. The wireless remote-control system of claim 1, wherein the first processing unit further comprises:
an instruction determining module, wherein when the first instruction receiving module receives the next remote-control instruction for the target device through the user interface, the instruction determining module determines whether the next remote-control instruction is the same as the remote-control instruction,
wherein when the next remote-control instruction and the remote-control instruction are different, the instruction transmitting module transmits the next remote-control instruction.

4. The wireless remote-control system of claim 1, wherein the first processing unit further comprises:
an instruction determining module, wherein when the first instruction receiving module receives the next remote-control instruction for the target device through the user interface, the instruction determining module determines whether the next remote-control instruction is the same as the remote-control instruction; and
a transmitting stop module, wherein when the next remote-control instruction and the remote-control instruction are the same, the transmitting stop module drives the instruction transmitting module to stop transmitting the next remote-control instruction.

5. The wireless remote-control system of claim 4, wherein the device to be controlled is a movable device, and the instruction determining module comprises:
a direction determiner, which determines whether the remote-controlled moving direction comprised in the next remote-control instruction is the same as that comprised in the remote-control instruction,
wherein, when the remote-controlled moving direction comprised in the next remote-control instruction is different from that comprised in the remote-control instruction, the instruction transmitting module transmits the next remote-control instruction with a different remote-controlled moving direction.

6. The wireless remote-control system of claim 4, wherein the device to be controlled is a movable device, and the instruction determining module comprises:
a speed variation determiner, which determines whether the speed variation request comprised in the next remote-control instruction is the same as that comprised in the remote-control instruction,
wherein when the speed variation request comprised in the next remote-control instruction is different from that comprised in the remote-control instruction, the instruction transmitting module transmits the next remote-control instruction with a different speed variation request.

7. The wireless remote-control system of claim 4, wherein the second processing unit further comprises:
an execution continuing module, wherein before the next remote-control instruction is received, the execution continuing module continuously drives the device to be controlled to perform the remote-control instruction.

8. The wireless remote-control system of claim 1, wherein the device to be controlled further comprises a speaker electrically connected to the second processing unit, and the remote-control instruction comprises an audio signal to be played, and the instruction execution module comprises:
an audio player, wherein when the identification information of the target device comprised in the remote-control instruction matches the identification information of the device to be controlled, the audio player controls the speaker of the device to be controlled to play the audio signal to be played.

9. The wireless remote-control system of claim 1, wherein the device to be controlled comprises a light generating component electrically connected to the second processing unit, and the instruction execution module comprises:
a light controller, which controls the light generating component according to the remote-control instruction.
